(19) United States
(12) Patent Application Publication
(10) Pub. No.: US 2018/0180933 A1
(43) Pub. Date: Jun. 28, 2018

(54) VERTICAL ALIGNMENT (VA) LIQUID CRYSTAL PANELS AND LIQUID CRYSTAL DISPLAYS (LCDS)

(71) Applicant: Shenzhen China Star Optoelectronics Technology Co., Ltd., Shenzhen, Guangdong (CN)

(72) Inventor: Sikun HAO, Shenzhen, Guangdong (CN)

(73) Assignee: Shenzhen China Star Optoelectronics Technology Co., Ltd., Shenzhen, Guangdong (CN)

(21) Appl. No.: 15/310,440

(22) PCT Filed: Oct. 20, 2016
(86) PCT No.: PCT/CN2016/102668

§ 371 Date: Nov. 10, 2016

(30) Foreign Application Priority Data
Jun. 3, 2016 (CN) 201610389788.9

(51) Int. Cl. G02F 1/1335

(52) U.S. Cl. CPC G02F 1/133514; G02F 2001/133357; G02F 1/133512

(57) ABSTRACT

The present disclosure relates to a VA liquid crystal panel and a LCD. The liquid crystal panel includes a first substrate and a second substrate opposite to the first substrate, and at least one red photo-resist, at least one green photo-resist, and at least one blue photo-resist arranged on the first substrate and/or the second substrate. A cell thickness of the blue photo-resist is smaller than the cell thickness of the red photo-resist and the green photo-resist. The contrast and the color shift issue under large viewing angle may be enhanced, and so does the display performance of the liquid crystal panel.

### BACKGROUND OF THE INVENTION

### 1. Field of the Invention

The present disclosure relates to liquid crystal display technology, and more particularly to a vertical alignment (VA) liquid crystal panel and a liquid crystal device (LCD).

### 2. Discussion of the Related Art

LCDs have become one of the fast-developed flat displays due to its lightness and thinness. However, compared with cathode ray tube (CRT) displays, viewing angles of thin film transistors (TFTs) in liquid crystal displays (TFT-LCDs) are relatively narrow, which greatly limits the applications in the high-end display areas, such as aerospace, medical and other fields. With the rapid development of wide viewing angle technology of LCDs, the horizontal and vertical viewing angle of LCDs may reach 85/85 degrees, or even larger.

The wide viewing angle technology of LCDs currently includes In Plane Switching (IPS) technology and Multi-domain Vertical Alignment (MVA) technology, where the IPS technology relates to forming the pixel electrode and the common electrode on a TFT array substrate in parallel, and the pixel electrode and the common electrode are distributed in a repeated fashion. In response to the horizontal electrical field, the liquid crystal molecules may rotate so as to form a wide viewing angle. The front contrast is usually below 2000: 1, and the front contrast of the MVA technology can usually reach 4000: 1 or the above. However, the color shift issue may happen under the wide viewing angle scenario.

### SUMMARY

The present disclosure relates to a VA liquid crystal panel and a LCD.

In one aspect, a vertical alignment (VA) liquid crystal panel includes: a first substrate and a second substrate opposite to the first substrate; at least one red photo-resist, at least one green photo-resist, and at least one blue photo-resist arranged on the first substrate and/or the second substrate; wherein a cell thickness of the blue photo-resist is smaller than the cell thickness of the red photo-resist and the green photo-resist; wherein the red photo-resist and the green photo-resist are configured on a surface of the first substrate facing toward the first substrate, and the blue photo-resist is configured on the surface of the second substrate facing toward the first substrate, and the blue photo-resist is spaced apart from the red photo-resist and the green photo-resist.

Wherein the first substrate configured with the red photo-resist and the green photo-resist is flat, and the surface of the second substrate facing toward the red photo-resist and the green photo-resist is recessed.

Wherein the liquid crystal panel further includes a planarization layer on the surface configured with the red photo-resist and the green photo-resist, and the surface of the first substrate faces toward the blue photo-resist.

Wherein the surface of the second substrate facing toward the first substrate is configured with a grid black matrix, the blue color resist fills a portion of lattice of the black matrix, and the remaining lattice of the black matrix are configured in a concave shape.

In one aspect, a vertical alignment (VA) liquid crystal panel includes: a first substrate and a second substrate opposite to the first substrate; at least one red photo-resist, at least one green photo-resist, and at least one blue photo-resist arranged on the first substrate and/or the second substrate; and wherein a cell thickness of the blue photo-resist is smaller than the cell thickness of the red photo-resist and the green photo-resist.

Wherein the red photo-resist and the green photo-resist are configured on a surface of the first substrate facing toward the first substrate, and the blue photo-resist is configured on the surface of the second substrate facing toward the first substrate, and the blue photo-resist is spaced apart from the red photo-resist and the green photo-resist.

Wherein the first substrate configured with the red photo-resist and the green photo-resist is flat, and the surface of the second substrate facing toward the red photo-resist and the green photo-resist is recessed.

Wherein the liquid crystal panel further includes a planarization layer on the surface configured with the red photo-resist and the green photo-resist, and the surface of the first substrate faces toward the blue photo-resist.

Wherein the surface of the second substrate facing toward the first substrate is configured with a grid black matrix, the blue color resist fills a portion of lattice of the black matrix, and the remaining lattice of the black matrix are configured in a concave shape.

In another aspect, a vertical alignment (VA) liquid crystal device (LCD) includes: a display panel and a backlight module being stacked; the display panel includes: a first substrate and a second substrate opposite to the first substrate; at least one red photo-resist, at least one green photo-resist, and at least one blue photo-resist arranged on the first substrate and/or the second substrate; and wherein a cell thickness of the blue photo-resist is smaller than the cell thickness of the red photo-resist and the green photo-resist.

Wherein the red photo-resist and the green photo-resist are configured on a surface of the first substrate facing toward the first substrate, and the blue photo-resist is configured on the surface of the second substrate facing toward the first substrate, and the blue photo-resist is spaced apart from the red photo-resist and the green photo-resist.

Wherein the first substrate configured with the red photo-resist and the green photo-resist is flat, and the surface of the second substrate facing toward the red photo-resist and the green photo-resist is recessed.

Wherein the liquid crystal panel further includes a planarization layer on the surface configured with the red photo-resist and the green photo-resist, and the surface of the first substrate faces toward the blue photo-resist.

Wherein the surface of the second substrate facing toward the first substrate is configured with a grid black matrix, the blue color resist fills a portion of lattice of the black matrix, and the remaining lattice of the black matrix are configured in a concave shape.

In view of the above, the first substrate and the second substrate to be opposite to each other, and at least one red photo-resist, at least one green photo-resist, and at least one blue photo-resist arranged on the first substrate and/or the second substrate. Wherein a cell thickness of the blue photo-resist is smaller than the cell thickness of the red photo-resist and the green photo-resist. As the wavelength of blue light beams is shorter than that of the red light beams and the green light beams, the cell thickness of the blue photo-resist is smaller than the cell thickness of the red photo-resist and the green photo-resist. The contrast and the color shift issue under large viewing angle may be enhanced, and so does the display performance of the liquid crystal panel.

### BRIEF DESCRIPTION OF THE DRAWINGS

FIG. 1 is a schematic view of one conventional liquid crystal panel.

FIG. 2 is a curve diagram showing the Gamma curve of the liquid crystal panel in FIG. 1 for a plurality of viewing angles.

FIG. 3 is a schematic view of the liquid crystal panel in accordance with one embodiment.

FIG. 4 is a schematic view showing the red photo-resist of the liquid crystal panel in accordance with one embodiment.

FIG. 5 is a schematic view showing the green photo-resist of the liquid crystal panel in accordance with one embodiment.

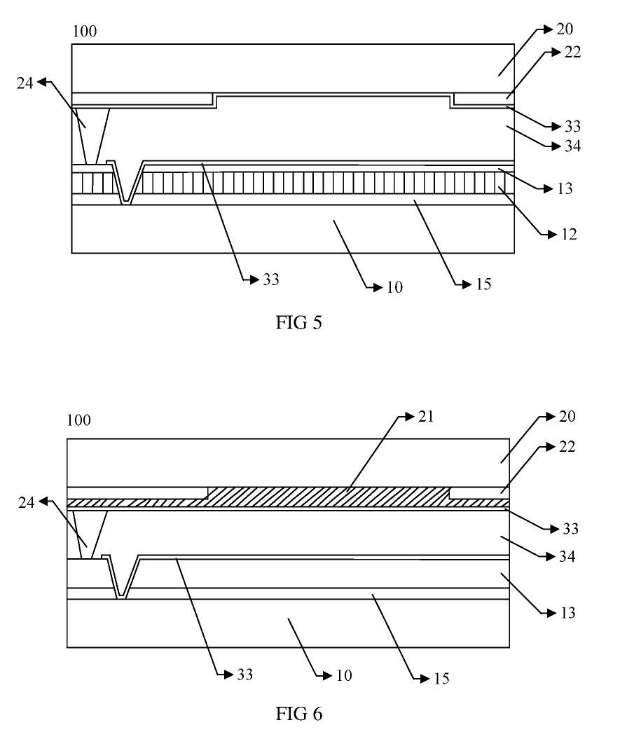

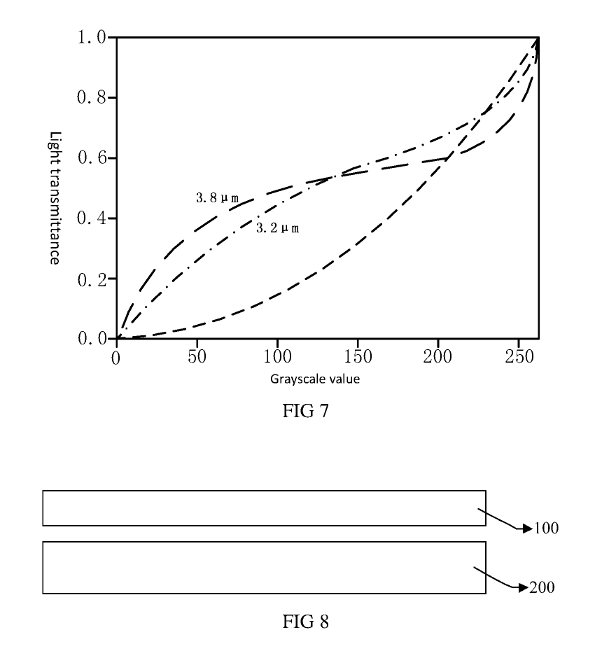

FIG. 4 is a schematic view showing the blue photo-resist of the liquid crystal panel in accordance with one embodiment.

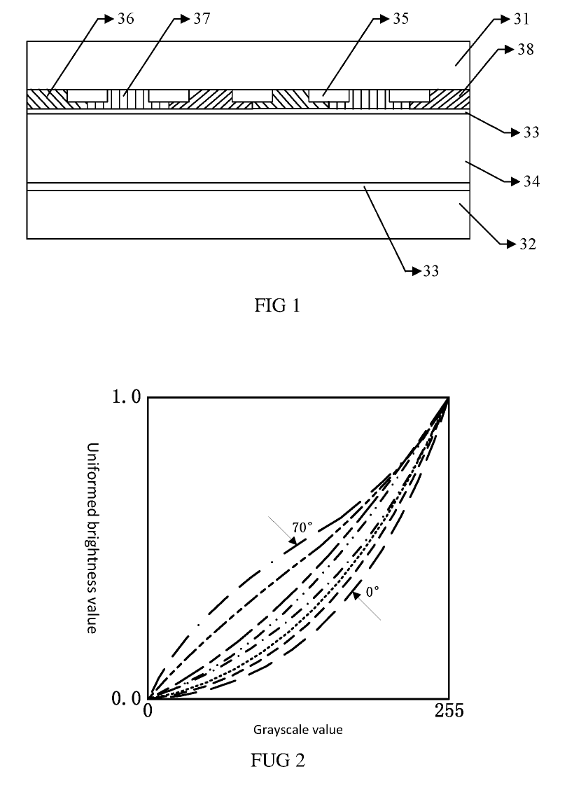

FIG. 7 is a schematic view showing the contrast of the viewing angle characteristics of the liquid crystal panel in accordance with one embodiment, when compared to that of the liquid crystal panel in FIG. 1.

FIG. 8 is a schematic view of the LCD in accordance with one embodiment.

### DETAILED DESCRIPTION OF THE EMBODIMENTS

Embodiments of the invention will now be described more fully hereinafter with reference to the accompanying drawings, in which embodiments of the invention are shown. In the drawings, in order to clearly illustrate the device, the thickness of layers and regions are exaggerated, and the same reference numerals throughout the specification and drawings can be used to denote the same elements.

FIG. 1 is a schematic view of one conventional liquid crystal panel. At least one red photo-resist 36, at least one green photo-resist 37, and at least one blue photo-resist 35 are arranged on a surface of a first substrate 31 facing toward a second substrate 32. An indium tin oxide (ITO) 33 is arranged on the first substrate 31 and the second substrate 32. A liquid crystal layer 34 is arranged between the first substrate 31 and the second substrate 32, wherein cell thickness of the red photo-resist 36, the green photo-resist 37, and the blue photo-resist 35 are the same. FIG. 2 shows the Gamma curves of the liquid crystal panel in FIG. 1 for a plurality of viewing angles. The viewing angle of the lowest Gamma curve is of zero degree. Along the increase of the viewing angle, the Gamma curve shifts upward. The viewing angle of the highest Gamma curve is of 70 degrees. It can be seen that the color shift issue may happen when the viewing angle is large, and the contrast of the images may drop.

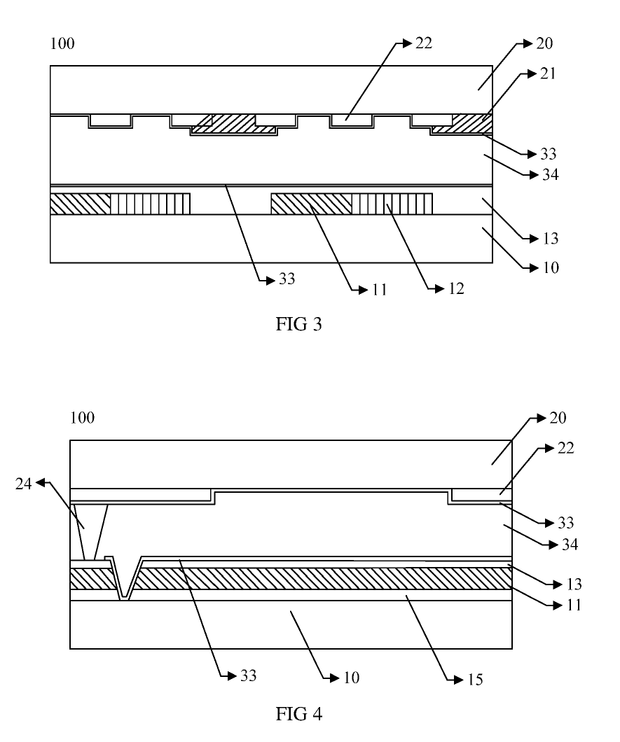

FIG. 3 is a schematic view of the liquid crystal panel in accordance with one embodiment. FIGS. 4, 5, and 6 are schematic views of the red photo-resist 11, the green photo-resist 12, and the blue photo-resist 21 of a liquid crystal panel 100. FIG. 7 is a schematic view showing the contrast of the viewing angle characteristics of the liquid crystal panel in accordance with one embodiment, when compared to that of the liquid crystal panel in FIG. 1, wherein the dashed Gamma curve is directed to one conventional liquid crystal panel 100. In view of the drawings, it can be seen that the Gamma curve of the liquid crystal panel 100 is more smooth, and the angle is approximate 45 degrees. Compared to the conventional liquid crystal panel in FIG. 1, the performance is enhanced.

Referring to FIG. 3, the liquid crystal panel 100 includes a first substrate 10, a second substrate 20 opposite to the first substrate 10, the red photo-resist 11, the green photo-resist 12, and the blue photo-resist 21 arranged on the first substrate 10 and/or the second substrate 20, wherein the cell thickness of the blue photo-resist 21 is smaller than the cell thickness of the red photo-resist 11 and the green photo-resist 12.

As the wavelength of blue light beams is shorter than that of the red light beams and the green light beams, the cell thickness of the blue photo-resist 21 is smaller than the cell thickness of the red photo-resist 11 and the green photo-resist 12. The blue photo-resist 21 is arranged to be spaced apart from the red photo-resist 11 and the green photo-resist 12. In addition, an appropriate difference of the cell thickness is configured between the blue photo-resist 21 and the red photo-resist 11, the green photo-resist 12 so as to enhance the contrast and the color shift issue when the viewing angle is large. Thus, the display performance of the liquid crystal panel may be enhanced.

Alternatively, the red photo-resist 11, the green photo-resist 12, and the blue photo-resist 21 may be formed by Poly-vinyl alcohol (PVA), acrylic paints, or other pigments or dyes to form the red, green, and blue colored patterns.

In addition, the red photo-resist 11 and the green photo-resist 12 are arranged on one surface of the first substrate 10 facing toward the second substrate 20. The other surface of the first substrate 10 is configured with a polarizer (not shown). The blue photo-resist 21 is arranged on one surface of the second substrate 20 facing toward the first substrate 10, and the blue photo-resist 21 is spaced apart from the red photo-resist 11 and the green photo-resist 12. The other surface of the second substrate 20 is configured with the polarizer (not shown).

Alternatively, the first substrate 10 and the second substrate 20 are transparent glass substrates.

Further, the surface of the first substrate 10 configured with the red photo-resist 11 and the green photo-resist 12 is flat, and the surface of the second substrate 20 facing toward the red photo-resist 11 and the green photo-resist 12 is recessed so as to form the structure where the cell thickness of the blue photo-resist 21 is smaller than the cell thickness of the red photo-resist 11 and the green photo-resist 12.

Alternatively, the liquid crystal panel further includes a planarization layer (PVA) 13 on the surface configured with the red photo-resist 11 and the green photo-resist 12, and the surface of the first substrate 10 faces toward the blue photo-resist 21.

Wherein the planarization layer 13 may be an organic planarization layer 13. It can be understood that the planarization layer 13 of the liquid crystal panel may be configured with a common electrode, a pixel electrode, and other appropriate structures.

Specifically, as shown in FIGS. 3 and 4, the surface of the first substrate 10 facing toward the second substrate 20 is configured with a passivation (PV) layer 15 and a planarization (PFA) layer 13 in sequence. The red photo-resist 11 and the green photo-resist are configured between the PV layer 15 and the PFA layer 13. The manufacturing process of the first substrate 10 is not limited to the disclosure. The first substrate 10 of the liquid crystal panel may be manufactured by an Array manufacturing process, an IGZO manufacturing process, or a LTPS manufacturing process. The amorphous is adopted to cover the red photo-resist 11, the green photo-resist 12, and the PFA layer 13 on the first substrate 10.

Further, the surface of the second substrate 20 facing toward the first substrate 10 is configured with a grid black matrix 22. The blue color resist 21 fills a portion of the lattice of the black matrix 22, and the remaining lattice of the black matrix 22 are configured in a concave shape. The remaining lattice of the black matrix 22, which are not filled with the blue photo-resist 21, form a missing portion of the photo-resists. The red photo-resist 11 and the green photo-resist 12 on the surface of the second substrate 20 facing toward the first substrate 10 correspond to the missing portion of the photo-resist of the first substrate 10 such that the structure, wherein the red photo-resist 11, the green photo-resist 12 on the first substrate 10 are spaced apart from the blue photo-resist 21 on the second substrate 20, is formed.

Wherein the black matrix 22 may be formed by black resin or metallic chrome.

Specifically, as shown in FIG. 5, the blue photo-resist 21 is configured with a pixel electrode layer 33 and a photo spacer (PS) (not shown).

In one embodiment, the red photo-resist 11 and the green photo-resist 12 are configured on the first substrate 10, and a planarization process is applied to the planarization layer 13. The second substrate 20 is opposite to the first substrate 10. The photo-resists are arranged on the second substrate 20 and the photo-resists correspond to the red photo-resist 11 and the green photo-resist 12. As the wavelength of the red light beams and the green light beams are longer than the wavelength of the blue light beams such that the cell thicknesses of the red photo-resist 11 and the green photo-resist 12 are greater than the cell thickness of the blue photo-resist 21. Thus, a greater difference of the cell thickness is configured between the blue photo-resist 21 and the red photo-resist 11, the green photo-resist 12 so as to enhance the contrast and the color shift issue when the viewing angle is large. Thus, the display performance of the liquid crystal panel may be enhanced.

FIG. 8 is a schematic view of the LCD in accordance with one embodiment. The LCD includes a display panel 100 and a backlight module 200 being stacked. The liquid crystal panel 100 may be any one of the liquid crystal panel in the above. Thus, the Gamma curve of the LCD may be enhanced, and so does the contrast and the color shift issue when the viewing angle is large. Also, the display performance of the LCD may be enhanced.

In other embodiments, the planarization layer 13 may be made by other materials, which is not limited to the present disclosure. In an example, the ITO pixel electrode layer 33 may be configured to replace the planarization layer 13.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A vertical alignment (VA) liquid crystal panel, comprising:
a first substrate and a second substrate opposite to the first substrate;
at least one red photo-resist, at least one green photo-resist, and at least one blue photo-resist arranged on the first substrate and/or the second substrate;
wherein a cell thickness of the blue photo-resist is smaller than the cell thickness of the red photo-resist and the green photo-resist;
wherein the red photo-resist and the green photo-resist are configured on a surface of the first substrate facing toward the first substrate, and the blue photo-resist is configured on the surface of the second substrate facing toward the first substrate, and the blue photo-resist is spaced apart from the red photo-resist and the green photo-resist.

2. The VA liquid crystal panel as claimed in claim 1, wherein the first substrate configured with the red photo-resist and the green photo-resist is flat, and the surface of the second substrate facing toward the red photo-resist and the green photo-resist is recessed.

3. The VA liquid crystal panel as claimed in claim 1, wherein the liquid crystal panel further comprises a planarization layer on the surface configured with the red photo-resist and the green photo-resist, and the surface of the first substrate faces toward the blue photo-resist.

4. The VA liquid crystal panel as claimed in claim 1, wherein the surface of the second substrate facing toward the first substrate is configured with a grid black matrix, the blue color resist fills a portion of lattice of the black matrix, and the remaining lattice of the black matrix are configured in a concave shape.

5. A vertical alignment (VA) liquid crystal panel, comprising:
a first substrate and a second substrate opposite to the first substrate;
at least one red photo-resist, at least one green photo-resist, and at least one blue photo-resist arranged on the first substrate and/or the second substrate; and
wherein a cell thickness of the blue photo-resist is smaller than the cell thickness of the red photo-resist and the green photo-resist.

6. The VA liquid crystal panel as claimed in claim 5, wherein the red photo-resist and the green photo-resist are configured on a surface of the first substrate facing toward the first substrate, and the blue photo-resist is configured on the surface of the second substrate facing toward the first substrate, and the blue photo-resist is spaced apart from the red photo-resist and the green photo-resist.

7. The VA liquid crystal panel as claimed in claim 6, wherein the first substrate configured with the red photo-resist and the green photo-resist is flat, and the surface of the second substrate facing toward the red photo-resist and the green photo-resist is recessed.

8. The VA liquid crystal panel as claimed in claim 6, wherein the liquid crystal panel further comprises a planarization layer on the surface configured with the red photo-resist and the green photo-resist, and the surface of the first substrate faces toward the blue photo-resist.

9. The VA liquid crystal panel as claimed in claim 6, wherein the surface of the second substrate facing toward the first substrate is configured with a grid black matrix, the blue color resist fills a portion of lattice of the black matrix, and the remaining lattice of the black matrix are configured in a concave shape.

10. A vertical alignment (VA) liquid crystal device (LCD), comprising:
a display panel and a backlight module being stacked;
the display panel comprises:
a first substrate and a second substrate opposite to the first substrate;
at least one red photo-resist, at least one green photo-resist, and at least one blue photo-resist arranged on the first substrate and/or the second substrate; and
wherein a cell thickness of the blue photo-resist is smaller than the cell thickness of the red photo-resist and the green photo-resist.

11. The VA LCD as claimed in claim 10, wherein the red photo-resist and the green photo-resist are configured on a surface of the first substrate facing toward the first substrate, and the blue photo-resist is configured on the surface of the second substrate facing toward the first substrate, and the blue photo-resist is spaced apart from the red photo-resist and the green photo-resist.

12. The VA LCD as claimed in claim 10, wherein the first substrate configured with the red photo-resist and the green photo-resist is flat, and the surface of the second substrate facing toward the red photo-resist and the green photo-resist is recessed.

13. The VA LCD as claimed in claim 10, wherein the liquid crystal panel further comprises a planarization layer on the surface configured with the red photo-resist and the green photo-resist, and the surface of the first substrate faces toward the blue photo-resist.

14. The VA LCD as claimed in claim 10, wherein the surface of the second substrate facing toward the first substrate is configured with a grid black matrix, the blue color resist fills a portion of lattice of the black matrix, and the remaining lattice of the black matrix are configured in a concave shape.
